(19) United States
(12) Patent Application Publication
(10) Pub. No.: US 2015/0235217 A1
(43) Pub. Date: Aug. 20, 2015

(54) PHOTOS TO DETECT FRAUD AT POINT OF SALE METHOD AND APPARATUS

(71) Applicant: MASTERCARD INTERNATIONAL INCORPORATED, Purchase, NY (US)

(72) Inventors: Kristofer PEREZ, New York, NY (US); Pedro J. CHAVARRIA, Hampton Bays, NY (US)

(73) Assignee: MASTERCARD INTERNATIONAL INCORPORATED, Purchase, NY (US)

(21) Appl. No.: 14/183,284

(22) Filed: Feb. 18, 2014

(51) Int. Cl. G06Q 20/40; G06Q 20/34

(52) U.S. Cl. CPC G06Q 20/4016; G06Q 20/40145; G06Q 20/34

(57) ABSTRACT

A system, method, and computer-readable storage medium configured to use cardholder photos captured at the time of purchase as a factor in fraud determination. Baseline cardholder photos may be submitted directly or via a social network.

### BACKGROUND

1. Field of the Disclosure

Aspects of the disclosure relate in general to financial services. Aspects include an apparatus, system, method and computer-readable storage medium to use cardholder photos captured at the time of purchase as a factor in fraud determination.

2. Description of the Related Art

A payment card is a card or some other representation of an account that can be used by a cardholder and accepted by a merchant to make a payment for a purchase or in payment of some other obligation. Payment cards can include, without limitation, credit cards, debit cards, charge cards, and Automated Teller Machine (ATM) cards. Payment cards provide the clients of a financial institution (“cardholders”) with the ability to pay for goods and services without the inconvenience of using cash.

The payment industry suffers from problems stemming from fraud. One problem is cashiers at point of sale locations fail to adequately verify that the person presenting the payment card is in fact the legitimate cardholder. As a result, payment networks and issuers often attempt to mitigate the risk by assessing the of fraud risk posed by a payment card transaction.

Generally, at least one payment card network currently provides fraud scoring for payment card transactions. Fraud scoring refers to an indication, or likelihood, that a payment transaction is fraudulent. In one fraud scoring system, the payment card network provides a number back to the payment card issuer between zero and 1,000, which translates into zero and 100 percent, in tenths of percentage points. To provide fraud-scoring capability, various vendors or payment card companies provide and market various different fraud scoring products. A payment network generally selects one of the vendor products to provide its customers (the card issuers) with one of fraud scoring and credit risk scoring that is accessible, for example, on a payment card network.

### SUMMARY

Embodiments include a system, apparatus, device, method and computer-readable medium configured to use cardholder photos captured at the time of purchase as a factor in fraud determination.

In an embodiment, a payment network comprises a network interface and a processor. The network interface receives financial transaction data representing a financial transaction. The financial transaction data includes a transaction amount, a merchant identifier, a Primary Account Number (PAN) of a payment card, and a captured representation of a cardholder taken at a time of purchase. A processor compares the captured representation with a reference representation of the cardholder. The processor scores the financial transaction based at least in part on comparing the captured representation with the reference representation, resulting in a financial transaction score. The payment network interface then transmits the financial transaction score to an issuer of the payment card.

### BRIEF DESCRIPTION OF THE DRAWINGS

FIG. 1 illustrates an embodiment of a system configured to use cardholder photos captured at the time of purchase as a factor in fraud determination.

FIG. 2 depicts a block diagram of a payment network server in a system configured to use cardholder photos captured at the time of purchase as a factor in fraud determination.

FIG. 3 illustrates a flow chart of an enrollment method in a system configured to use cardholder photos captured at the time of purchase as a factor in fraud determination.

FIG. 4 depicts a flow chart of a method of fraud detection using cardholder photos captured at the time of purchase.

FIG. 5 depicts a diagram of a point of sale terminal in a system configured to use cardholder photos captured at the time of purchase as a factor in fraud determination.

### DETAILED DESCRIPTION

One aspect of the disclosure includes the understanding that a full-face image of a cardholder, captured at the time of purchase (referred to as a “point of sale cardholder image” or “captured image”), may be used to verify the identity of the cardholder.

Yet another aspect of the disclosure is the realization that a comparison between point of sale captured cardholder images and baseline (also referred to as a “reference” or “verification”) cardholder images may be automated by a payment card issuer or payment network.

Another aspect of the disclosure includes the realization that reference cardholder images may be received from a cardholder directly or via a social network. As avid users of social networking websites frequently update photos, cardholder images received from a social network may be more timely and may reflect changes in cardholder appearance. For example, if a cardholder loses one hundred pounds, grows a beard, starts or stops using glasses, or changes hairstyle, his appearance may vary significantly from a government photo identification document, such as a driver's license or passport.

For the purposes of this disclosure, a payment card includes, but is not limited to: credit cards, debit cards, prepaid cards, electronic checking cards, stored-value cards, or CHIP-enabled payment cards that comply with the International Organization for Standardization (ISO) and the International Electrotechnical Commission (IEC) Standard 7816 (ISO/IEC 7816). It is further understood that payment cards, as described herein, may also include an electronic wallet, virtual accounts, Radio Frequency Identifier (RFID) device, cloud-based payment device, mobile phone, Near Field Communication (NFC) enabled device, or any other electronic payment device known in the art.

Embodiments of the present disclosure include a system, apparatus, method, and computer-readable storage medium configured to use cardholder photos captured at the time of purchase as a factor in fraud determination.

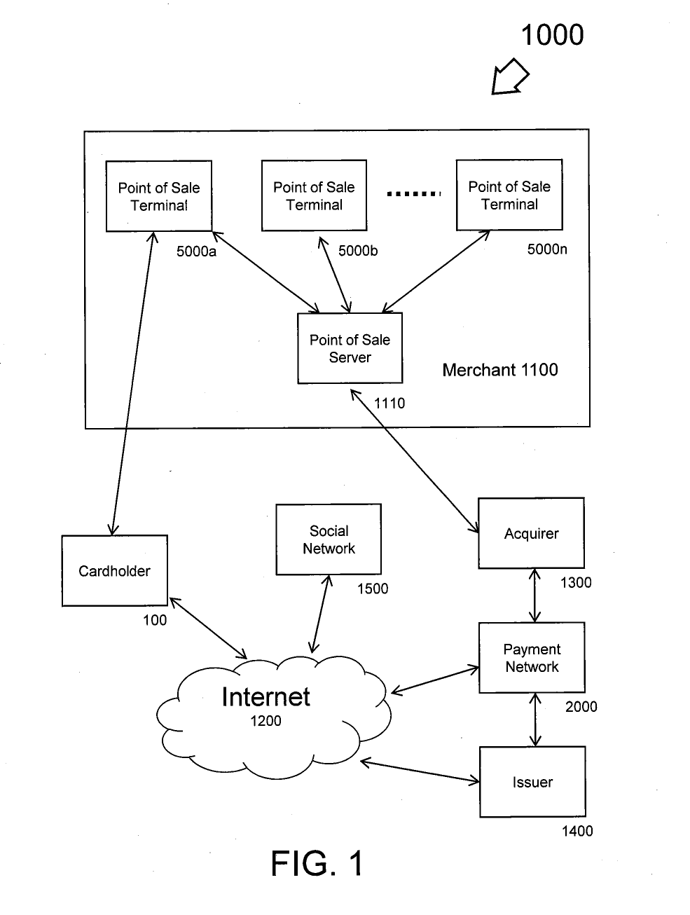

Embodiments will now be disclosed with reference to a block diagram of an exemplary system 1000 of FIG. 1 configured to use cardholder photos captured at the time of purchase as a factor in fraud determination, constructed and operative in accordance with an embodiment of the present disclosure.

System 1000 includes cardholders 100 using payment cards at a point of sale terminal 5000 at a merchant 1100; system 1000 further includes an acquirer financial institution 1300 (“acquirer”), a payment network 2000, and an issuer financial institution 1400 (“issuer”). In some embodiments, a cardholder 100 or social network 1500 may communicate with payment network 2000 or issuer 1400 over a wide area network (WAN), such as the Internet 1200 or via other communication means known in the art.

A merchant 1100 may be any vendor or service provider known in the art. Merchant 1100 may have multiple point of sale terminals 5000a-n and a point of sale server 1110. A point of sale server 1110 is a device configured to collect and manage information from point of sale terminals 5000a-n; in some embodiments, point of sale server 1110 facilitates communication between point of sale terminals 5000a-n and acquirer 1300. It should be understood that the point of sale server 1110 may be physically reside at the same location as merchant 1100, or alternatively, the point of sale server 1110 may be located at a location remote to the merchant 1100 location.

An acquirer 1300 (sometimes known as an “acquiring bank” or “merchant bank”) is the bank or other financial institution that processes card payments for products or services for a merchant 1100. The term acquirer indicates a financial institution that accepts or acquires card payments from the card-issuing banks within a payment network. In some instances, a merchant may act as its own acquirer or perform subsets of acquiring functions.

A payment network 2000 is a network capable of facilitating non-cash payments electronically. An example payment network 2000 includes MasterCard International Incorporated of Purchase, N.Y., the assignee of the present disclosure. Payment networks may support multiple merchants 1100, acquirers 1300 and issuers 1400, or single merchant/acquiring and/or issuing entities.

An issuer 1400 (also known as an “issuing bank”) is a bank or other type of financial institution that offers payment network-branded payment cards directly to consumers (also known as “cardholders”). In a typical purchase transaction, issuer 1400 issues payment to the merchant 1100 or acquirer 1300 on behalf of its cardholder (the purchaser).

A social network 1500 is an electronic platform to build social relations among people who, for example, share interests, activities, backgrounds, or real-life connections. A social network 1500 may enable a representation of each user (often a profile), their social links, and a variety of additional services. A social network 1500 may allow users to interact over the Internet, such as e-mail and instant messaging. Social network 1500 allows users to share ideas, pictures, posts, activities, events, and interests with people in their network. In social networks that allow sharing of pictures, users may “tag” the identity of individuals in the shared photos.

When a payment card transaction commences, a cardholder purchases a good or service at a point of sale terminal 5000. The point of sale terminal 5000 captures transaction information, including the transaction amount, a merchant identifier, the Primary Account Number (PAN) of the payment card, and a picture of the cardholder taken at the time of the transaction. The transaction information is routed to a point of sale server 1110, and is in turn routed to an acquirer 1300, and then a payment network 2000. Payment network 2000 performs a risk analysis, based in part on comparing the captured image with a reference image of the cardholder. The payment network 2000 scores the transaction, and forwards the transaction information and the score to an issuer 1400. The issuer 1400 may then either approve or decline the transaction.

Example embodiments and method uses of point of sale terminal 5000 and payment network 2000 are discussed below.

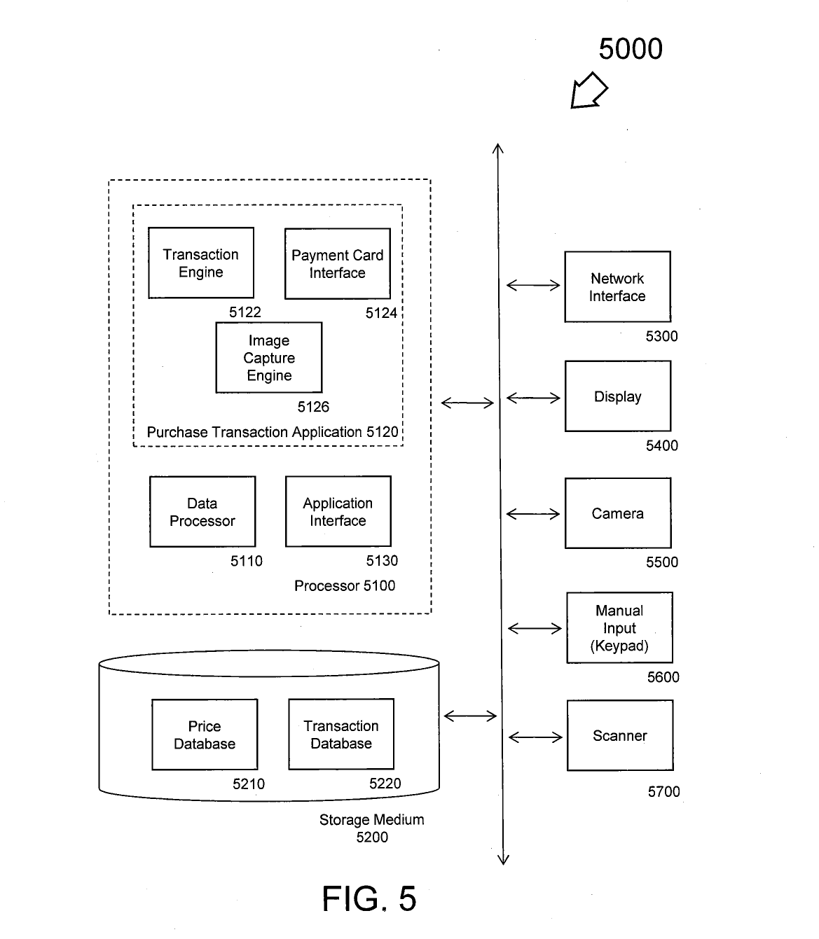

Embodiments will now be disclosed with reference to a block diagram of a point of sale terminal 5000 of FIG. 5 designed to use cardholder photos captured at the time of purchase as a factor in fraud determination, constructed and operative in accordance with an embodiment of the present disclosure. Deployed at merchant 1100, point of sale terminal 5000 may be used to process a payment card transaction. As part of the payment card transaction, a photograph is taken of the purported cardholder. The photo, or a representation thereof, is sent via the point of sale server 1110 to an acquirer 1300, and then to a payment network 2000 for input as part of the fraud analysis.

Point of sale terminal 5000 may be an intelligent cash register, standalone kiosk, tablet computer, or other mobile device used to process a point of sale transaction. In this example, point of sale terminal 5000 is a cash register. As mentioned above, it is understood by those familiar with the art that point of sale terminal 5000 may be a mobile phone, tablet computer, personal digital assistant (PDA) or other portable computing device known in the art capable of processing a payment transaction, taking a picture of the purported cardholder, and transmitting the picture to a payment network 2000.

Point of sale terminal 5000 may run a real-time multi-tasking operating system (OS) and include at least one processor or central processing unit (CPU) 5100, a non-transitory computer-readable storage medium 5200, a network interface 5300, a display 5400, and a camera 5500. Point of sale terminal 5000 may further include manual input 5600, and an optical scanner 5700.

Processor 5100 may be any central processing unit, microprocessor, micro-controller, computational device or circuit known in the art. It is understood that processor 5100 may temporarily store instructions and data in Random Access Memory (not shown).

As shown in FIG. 5, processor 5100 is functionally comprised of a data processor 5110, a purchase transaction application 5120, and application interface 5130.

Data processor 5110 enables processor 5100 to interface with storage medium 5200, network interface 5300, display 5400, camera 5500, manual input 5600, scanner 5700, computer memory or any other component not on the processor 5100. The data processor 5110 enables processor 5100 to locate data on, read data from, and write data to these components.

Application interface 5130 may be any graphical user interface known in the art to facilitate communication with the user of the point of sale terminal 5000; as such, application interface 5130 may communicate with the user via display 5400, camera 5500, manual input 5600, or scanner 5700.

Purchase transaction application 5120 enables the functionality to facilitate a financial transaction. Purchase transaction application 5120 may further comprise: transaction engine 5122, payment card interface 5124, and image capture engine 5126.

A transaction engine 5122 is the structure that enables purchase transaction application 5120 to obtain the price of a good or service from price database 5210, and tally the items and services purchased or returned.

Payment card interface 5124 enables the transaction engine 5122 to process payment cards in a financial transaction.

Image capture engine 5126 enables the processing of a cardholder full-face image from camera 5500. Image capture engine 5126 may process the cardholder full-face image into a variety of compressed image formats, including, but not limited to: Graphics Interchange Format (GIF), Joint Photographic Experts Group (JPEG), Joint Photographic Experts Group 2000 (JPEG 2000), Progressive Graphics File (PGF), or Portable Network Graphics (PNG). In other embodiments, image capture engine 5126 may include facial recognition processes to identify facial features by extracting landmarks or features from an image of the cardholder. In such an embodiment, the image capture engine 5126 may analyze the relative position, size, and/or shape of the eyes, nose, cheekbones, and jaw; the face data may then be compressed, only saving the data in the image that is useful for face recognition. This data may then be transmitted to payment network 2000 for comparison to a baseline or reference cardholder photos.

Image capture engine 5126 may use one of several approaches: skin texture analysis, which turns the unique lines, patterns, and spots apparent on a person's skin into a mathematical space; geometric analysis, which looks at distinguishing features; or photometric analysis, which is a statistical approach that distills an image into values and compares the values with templates to eliminate variances. Additionally, image capture engine 5126 may implement Principal Component Analysis using Eigen faces, Linear Discriminate Analysis, Elastic Bunch Graph Matching (such as the Fisherface algorithm), the Hidden Markov model, Multilinear Subspace Learning (tensor representation), and/or the neuronal motivated dynamic link matching.

These structures may be implemented as hardware, firmware, or software encoded on a computer readable medium, such as storage medium 5200. Further details of these components are described with their relation to method embodiments below.

Network interface 5300 may be any data port as is known in the art for interfacing, communicating or transferring data across a computer network. Network interface 5300 allows point of sale terminal 5000 to communicate with a point of sale server 1110, acquirer 1300, or other entities.

Display 5400 may be any liquid crystal display (LCD) display, light emitting diode (LED) screen, touch-sensitive screen, or other monitor known in the art for visually displaying images and text to a user.

A camera 5500 may be any image capture device configured to capture the image of a cardholder. Scanner 5700 may be any optical scanner to capture barcode images, as is known in the art. In some embodiments, camera 5500 may also act as scanner 5700. It is understood that scanner 5700 and camera 5500 may include appropriate digital-to-analog and analog-to-digital conversion circuitry as appropriate.

Manual input 5600 may be buttons, a conventional keyboard, keypad, track pad, trackball, or other input device as is known in the art for the manual input of data. In some embodiments, manual input 5600 may be integrated into a touch-sensitive display 5400. In other embodiments, manual input 5600 may be a virtual keyboard.

Storage medium 5200 may be a conventional read/write memory such as a flash memory, memory stick, transistor-based memory, or other computer-readable memory device as is known in the art for storing and retrieving data.

In addition, as shown in FIG. 5, storage medium 5200 may also contain a price database 5210 and transaction database 5220. A price database 5210 includes pricing records for products and services at merchant 1100. Transaction database 5220 includes records for all transactions that occur at point of sale terminal 5000. It is understood by those familiar with the art that these databases 5210-5220 may be combined in a myriad of combinations.

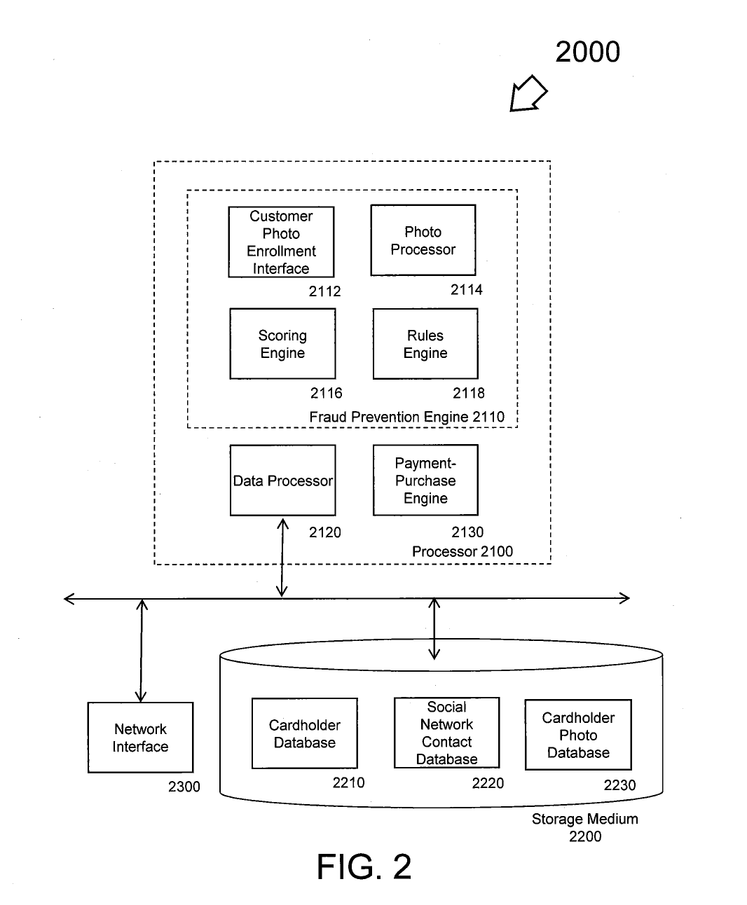

Embodiments will now be disclosed with reference to a block diagram of an exemplary payment network server 2000 of FIG. 2 configured to use cardholder photos captured at the time of purchase as a factor in fraud determination, constructed and operative in accordance with an embodiment of the present disclosure.

Payment network server 2000 may run a multi-tasking operating system (OS) and include at least one processor or central processing unit (CPU) 2100, a non-transitory computer-readable storage medium 2200, and a network interface 2300. An example operating system may include Advanced Interactive Executive (AIX™) operating system, UNIX operating system, or LINUX operating system, and the like.

Processor 2100 may be any central processing unit, microprocessor, micro-controller, computational device or circuit known in the art. It is understood that processor 2100 may communicate with and temporarily store information in Random Access Memory (RAM) (not shown).

As shown in FIG. 2, processor 2100 is functionally comprised of a fraud prevention engine 2110, a data processor 2120, and a payment-purchase engine 2130.

Data processor 2120 enables processor 2100 to interface with storage medium 2200, network interface 2300 or any other component not on the processor 2100. The data processor 2120 enables processor 2100 to locate data on, read data from, and write data to these components.

Payment-purchase engine 2130 is configured to facilitate the electronic payment transaction between cardholder 100 and merchant 1100 through communicating with acquirer 1300 and issuer 1400.

Fraud prevention engine 2110 is a component configured to perform risk estimation by analyzing financial transactions. Fraud prevention engine 2110 may further comprise: a customer photo enrollment interface 2112, photo processor 2114, scoring engine 2116, and rules engine 2118.

Customer photo enrollment interface 2112 is an application interface that allows cardholders to opt into using cardholder photos captured at the time of purchase as a factor in fraud determination. Once cardholders opt-in via the customer photo enrollment interface 2112, a record corresponding to the payment card in a cardholder database 2210 is updated, showing the enrollment. In embodiments that interface with a social network 1500, customer photo enrollment interface 2112 receives the cardholder's account information for the social network 1500 and updates a social network contact database 2220.

Photo processor 2114 is the structure or component capable of processing photo information received as an upload from the cardholder 100 or social network 1500. Photo processor 2114 may store the photo data in a cardholder photo database 2230. Photo processor 2114 may receive the cardholder full-face image into a variety of compressed image formats, including but not limited to: Graphics Interchange Format (GIF), Joint Photographic Experts Group (JPEG), Joint Photographic Experts Group 2000 (JPEG 2000), Progressive Graphics File (PGF), or Portable Network Graphics (PNG). In other embodiments, photo processor 2114 may analyze skin texture and/or facial features by extracting landmarks or features from an image of the cardholder.

Scoring engine 2116 is a structure configured to fraud score a financial transaction. Example scoring engines can be found in U.S. Pat. Nos. 7,428,509 and 8,126,791, both assigned to MasterCard International Incorporated. Additionally, in some embodiments, fraud prevention engine 2110 may have a rules engine 2118 to facilitate rules-based fraud-prevention algorithms.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with cardholder computing devices, social network 1500, acquirer 1300, and issuer 1400.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a cardholder database 2210, a social network contact database 2220, and a cardholder photo database 2230. Cardholder database 2210 is configured to store cardholder information and transactions information related to specific cardholders. Social network contact database 2220 is configured to store cardholder social network information. A cardholder photo database 2230 is a database storing cardholder photos.

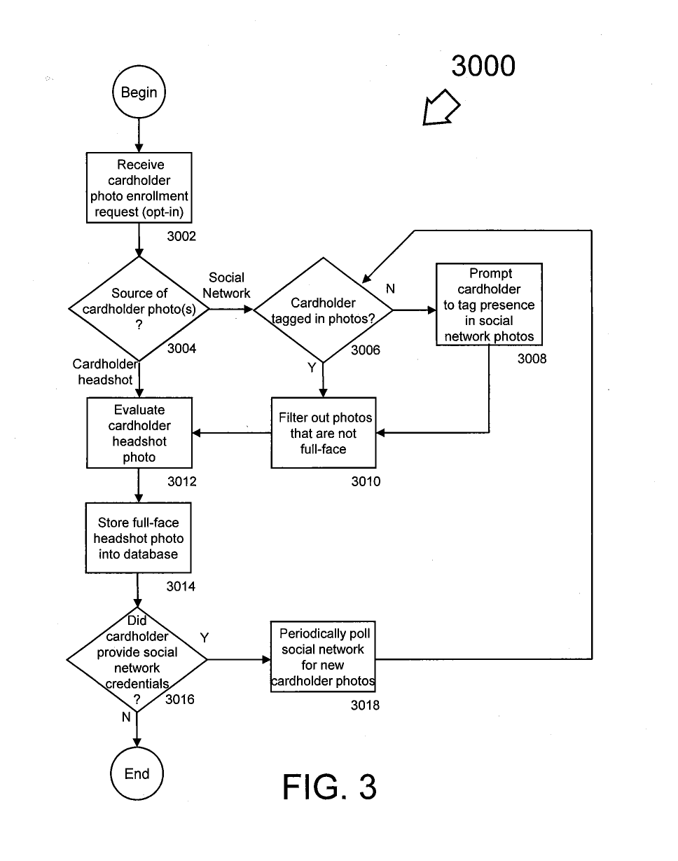

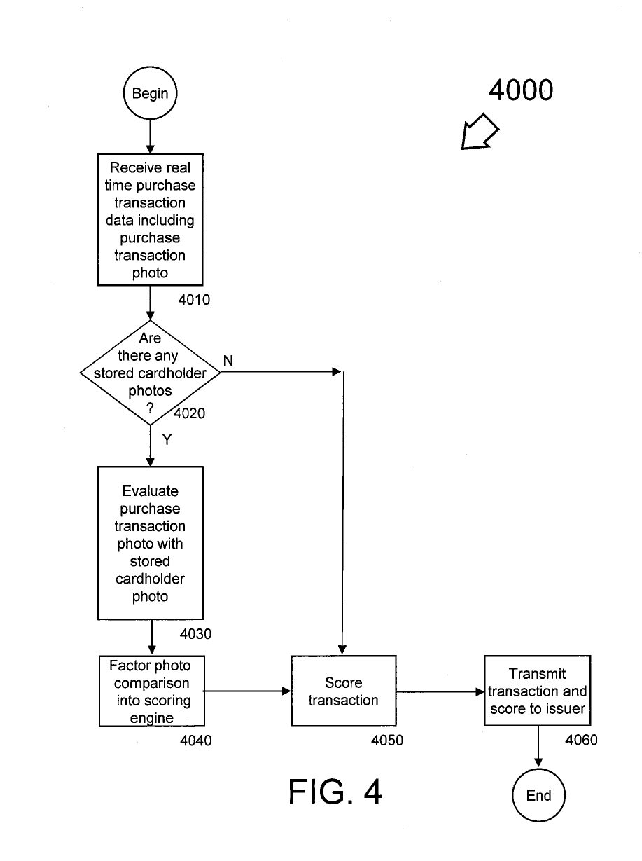

It is understood by those familiar with the art that one or more of these databases 2210-2230 may be combined in a myriad of combinations. The function of these structures may best be understood with respect to the flowcharts of FIGS. 3-4, as described below.

We now turn our attention to the method or process embodiments of the present disclosure described in the flow diagrams of FIGS. 3-4. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 illustrates a flow chart of a payment network 2000 method 3000 of opting-in to using cardholder photos captured at the time of purchase as a factor in fraud determination, constructed and operative in accordance with an embodiment of the present disclosure. When a cardholder opts into using cardholder photos as a factor in fraud determination, cardholders are prompted to provide full-face photos of themselves via a direct upload or via social network 1500.

At block 3002, payment network 2000 receives a cardholder opt-in request at customer photo enrollment interface 2112 via network interface 2300. The opt-in request may be received via a cardholder 100 visit to an issuer 1400 or payment network 2000 web-site, cardholder mobile device, or other networking option known in the art. As part of the opt-in request, cardholders are prompted to provide full-face headshot photos of themselves. The photos may be provided via a direct upload to customer photo enrollment interface 2112. In such a social network embodiment, the cardholder may be prompted to provide a link or login information for the cardholder's social media account on social network 1500; the link or login information is stored in a social network contact database 2220.

It should be noted that in some embodiments of process 3000, multiple reference cardholder photos may be used and processed.

Decision block 3004 determines the source of the cardholder photos. If the cardholder photos are directly uploaded by the cardholder, the process 3000 continues at block 3012. If the cardholder photos are provided by a social network, the process 3000 continues at block 3006.

When the cardholder reference photos are provided by a social network, the reference photos may be periodically be updated through photo postings by the cardholder. In the social network, the cardholder may be tagged in the photos, as determined at decision block 3006. If the cardholder is tagged in the photo, the process continues at block 3010. If the cardholder is not tagged within the photos, the customer photo enrollment interface 2112 prompts the cardholder to tag their presence in social network photos, block 3008. At this point, the process continues at block 3010.

At block 3010, photos that are not full-face are filtered out by photo processor 2114. A full-face photo of the cardholder is easier to use as a reference photo.

Moving to block 3012, photo processor 2114 evaluates each cardholder headshot photo for suitability in the fraud prevention process. Image characteristics include geometries, color, and accessories. Geometries include relative distances from facial features, such as distance from eye-to-eye, nose-to-lips, and the like. Color includes eye color, hair color, skin tone, and the like. Accessories may include glasses, ear rings, and the like.

At block 3014, the full-face headshot photos that are deemed suitable are stored in the cardholder photo database 2230. Note that in some embodiments, an information subset of the photos is taken and stored within the cardholder photo database 2230. For example, a hash of the cardholder photo may be stored, to be used in comparison with image information to be taken at the time of the financial transaction. In yet other embodiments, photo processor 2114 performs facial recognition processes to identify facial features by extracting landmarks or features from an image of the cardholder. In such an embodiment, the photo processor 2114 may analyze: skin texture, the relative position, size, and/or shape of the eyes, nose, cheekbones, and jaw; the face data may then be compressed, only saving the data in the image that is useful for face recognition. Additionally, photo processor 2114 may implement Principal Component Analysis using Eigen faces, Linear Discriminate Analysis, Elastic Bunch Graph Matching (such as the Fisherface algorithm), the Hidden Markov model, Multilinear Subspace Learning (tensor representation), and/or the neuronal motivated dynamic link matching. The cardholder facial data may then be saved for future comparison in cardholder photo database 2230.

If the cardholder provided social network links, login information, or other network credentials, as determined at decision block 3016, the process periodically polls social network 1500 for new cardholder photos, at block 3018. The process flow then returns to block 3006.

Moving to FIG. 4, process 4000 is a payment network method to use cardholder photos captured at the time of purchase as a factor in fraud determination, constructed and operative in accordance with an embodiment of the present disclosure.

When a payment card transaction commences, a cardholder purchases a good or service at a point of sale terminal 5000. The point of sale terminal 5000 captures transaction information, including the transaction amount, a merchant identifier, the Primary Account Number (PAN) of the payment card, and an electronic picture of the cardholder taken at the time of the transaction. The picture of the presumed cardholder is taken by camera 5500, and may be in any picture format known in the art. In some embodiments an electronic representation of the photograph, such as a hash, may be transmitted in lieu of the picture itself. The transaction information is routed to a point of sale server 1110, via the point of sale network interface 5300, and is in turn routed to an acquirer 1300, and then a payment network 2000.

At block 4010, payment-purchase engine 2130 receives the transaction information. Using the Primary Account Number, the cardholder information is retrieved from the cardholder database 2210; furthermore, if a reference cardholder photo is stored in the cardholder photo database 2230, as determined at decision block 4020, the process continues at block 4030. If no reference cardholder photo is stored, the process continues at block 4050.

At block 4030, the received purported cardholder photo is compared with the stored reference cardholder photo. In such an embodiment, the photo processor 2114 may analyze the relative position, size, and/or shape of the eyes, nose, cheekbones, and jaw. As mentioned above, photo processor 2114 may implement a variety of different facial recognition techniques to perform the comparison. When multiple stored reference cardholder photos are available, then the comparison may be made to one or more of the reference cardholder photos. In some embodiments, statistical deviation from pre-captured metrics may be applied. For example, based on all pictures stored in cardholder photo database 2230 in the past 6 months, eyes are between 3.2-3.5 cm apart. The received purported cardholder photo is compared to see if it falls within that range. The percentage matching comparison is then submitted with the transaction amount, merchant identifier, and Primary Account Number as factors in the fraud scoring analysis, block 4040.

At block 4050, the transaction is scored. The score is sent to the issuer 1400 to be accepted or declined, block 4060.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A payment network method comprising:
receiving financial transaction data representing a financial transaction via a network interface, the financial transaction data including: a transaction amount, a merchant identifier, a Primary Account Number (PAN) of a payment card, and a captured representation of a cardholder taken at a time of purchase;
comparing, with a processor, the captured representation with a reference representation of the cardholder;
scoring the financial transaction, with the processor, based at least in part on comparing the captured representation with the reference representation, resulting in a financial transaction score;
transmitting the financial transaction score based at least in part on comparing the captured representation with the reference representation to an issuer of the payment card, via the network interface.

2. The payment network method of claim 1, wherein reference representation of the cardholder is from a social network.

3. The payment network method of claim 2, wherein the captured representation of the cardholder taken at the time of purchase is a photo.

4. The payment network method of claim 3, wherein the comparison uses geometric facial recognition.

5. The payment network method of claim 3, wherein the comparison uses photometric facial recognition.

6. The payment network method of claim 3, wherein the comparison uses skin texture analysis.

7. The payment network method of claim 2, wherein the captured representation of the cardholder taken at the time of purchase is a relative position of facial features.

8. A payment network comprising:
a network interface configured to receive financial transaction data representing a financial transaction, the financial transaction data including: a transaction amount, a merchant identifier, a Primary Account Number (PAN) of a payment card, and a captured representation of a cardholder taken at a time of purchase;
a processor configured to compare the captured representation with a reference representation of the cardholder, and to score the financial transaction based at least in part on comparing the captured representation with the reference representation, resulting in a financial transaction score;
wherein the network interface further configured to transmit the financial transaction score based at least in part on comparing the captured representation with the reference representation to an issuer of the payment card, via the network interface.

9. The payment network of claim 8, wherein reference representation of the cardholder is from a social network.

10. The payment network of claim 9, wherein the captured representation of the cardholder taken at the time of purchase is a photo.

11. The payment network of claim 10, wherein the comparison uses geometric facial recognition.

12. The payment network of claim 10, wherein the comparison uses photometric facial recognition.

13. The payment network of claim 10, wherein the comparison uses skin texture analysis.

14. The payment network of claim 9, wherein the captured representation of the cardholder taken at the time of purchase is a relative position of facial features.

15. A non-transitory computer readable medium encoded with data and instructions, when executed by a mobile device the instructions causing the mobile device to:
receive financial transaction data representing a financial transaction via a network interface, the financial transaction data including: a transaction amount, a merchant identifier, a Primary Account Number (PAN) of a payment card, and a captured representation of a cardholder taken at a time of purchase;
compare, with a processor, the captured representation with a reference representation of the cardholder;
score the financial transaction, with the processor, based at least in part on comparing the captured representation with the reference representation, resulting in a financial transaction score;
transmit the financial transaction score based at least in part on comparing the captured representation with the reference representation to an issuer of the payment card, via the network interface.

16. The payment network method of claim 15, wherein reference representation of the cardholder is from a social network.

17. The payment network method of claim 16, wherein the captured representation of the cardholder taken at the time of purchase is a photo.

18. The payment network method of claim 17, wherein the comparison uses geometric facial recognition.

19. The payment network method of claim 17, wherein the comparison uses photometric facial recognition.

20. The payment network method of claim 17, wherein the comparison uses skin texture analysis.
